(19) United States
(12) Patent Application Publication
(10) Pub. No.: US 2013/0036068 A1
(43) Pub. Date: Feb. 7, 2013

(54) LOGISTICAL MANAGEMENT OF CARGO SHIPMENTS

(71) Applicants: Andrew Smith, Pleasanton, CA (US); Claude-Nicolas Fiechter, San Jose, CA (US); David Cope, Los Gatos, CA (US); Ray Hoobler, Pleasanton, CA (US)

(72) Inventors: Andrew Smith, Pleasanton, CA (US); Claude-Nicolas Fiechter, San Jose, CA (US); David Cope, Los Gatos, CA (US); Ray Hoobler, Pleasanton, CA (US)

(21) Appl. No.: 13/204,613

(22) Filed: Aug. 5, 2011

(51) Int. Cl. G06Q 10/08; G06F 7/60

(52) U.S. Cl. 705/332; 703/2

(57) ABSTRACT

The present application is directed to systems and methods for logistical management of a cargo shipment. An exemplary method comprises receiving input data related to the cargo. An analysis of the input data may then be performed, and a logistical or movement protocol for the cargo shipment may be modified based on the results of the input data analysis. Various embodiments of the methods may also include comparing the input data to at least one predetermined standard and modifying the logistical or movement protocol if the input data deviates from the standard by at least a predetermined amount.

### FIELD OF THE INVENTION

The present invention is directed generally to systems and methods for the logistical management of a cargo shipment, and more specifically to modifying a logistical or movement protocol for the cargo shipment based on data analysis.

### SUMMARY

The present application is directed to systems and methods for logistical management of a cargo shipment. An exemplary method comprises receiving input data related to the cargo. An analysis of the input data may then be performed, and a logistical or movement protocol for the cargo shipment may be modified based on the results of the input data analysis. Various embodiments of the methods may also include comparing the input data to at least one predetermined standard and modifying the logistical or movement protocol if the input data deviates from the standard by at least a predetermined amount. The analysis of input data in various embodiments may comprise determining a remaining useful life of the cargo shipment, and calculating a freshness index for a perishable cargo shipment. The results of any of these analyses may be used to modify or adjust the logistical or movement protocol for the cargo shipment.

### BRIEF DESCRIPTION OF THE DRAWINGS

FIG. 1 is an exemplary flow diagram of a method for logistical management of a cargo shipment according to various embodiments.

FIG. 2 is an exemplary flow diagram of a method for logistical management of a cargo shipment according to various embodiments.

FIG. 3 is an exemplary flow diagram of a method for logistical management of a cargo shipment according to various embodiments.

FIG. 4 is a diagram of exemplary data inputs for a method for logistical management of a cargo shipment according to various embodiments.

FIG. 5A is an exemplary graph of a data analysis according to various embodiments.

FIG. 5B is an exemplary graph of a data analysis according to various embodiments.

FIG. 6 is a schematic diagram of an exemplary architecture of a data logging and communication system according to various embodiments.

FIG. 7 is a block diagram of an exemplary computing system that may be utilized to practice aspects of the present disclosure.

### DETAILED DESCRIPTION

The present application is directed to systems and methods for determining logistical management of a cargo shipment. An exemplary method comprises receiving input data related to the perishability of the cargo. An analysis of the input data may then be performed, and a logistical or movement protocol for the cargo shipment may be modified based on the results of the input data analysis. Various embodiments of the methods may also include comparing the input data to at least one predetermined standard and modifying the logistical or movement protocol if the input data deviates from the standard by at least a predetermined amount. The analysis of input data in various embodiments may comprise determining a remaining useful life of the cargo shipment, and calculating a freshness index for the cargo shipment. The results of any of these analyses may be used to modify or adjust the logistical or movement protocol for the cargo shipment.

Many cargo shipments are comprised of perishable cargo, such as fruits, vegetables, meats, frozen items, chemicals, and pharmaceuticals. Even live animals are shipped as cargo, such as the shipment of live fish to fisheries and pet stores. For most perishable cargo, the quality of the cargo may degrade if certain conditions vary more than a predetermined amount from standard shipping parameters for the specific type of cargo. For example, fruits can decay at a faster rate if a standard temperature is exceeded during shipping. Likewise, the survivability of live animals may be impacted if the oxygen content in the shipping container falls below a standard amount. Studies have shown that as much as 20 percent of fresh produce shipments arrives damaged by decay. Considering that approximately 4 million refrigerated cargo containers are shipped annually, the economic impact of damage to perishable cargo is staggering. The methods of the present invention address the need to track data related to cargo shipments and predict how logistical or movement protocols associated with the cargo shipment may be modified to reduce damage to perishable cargo.

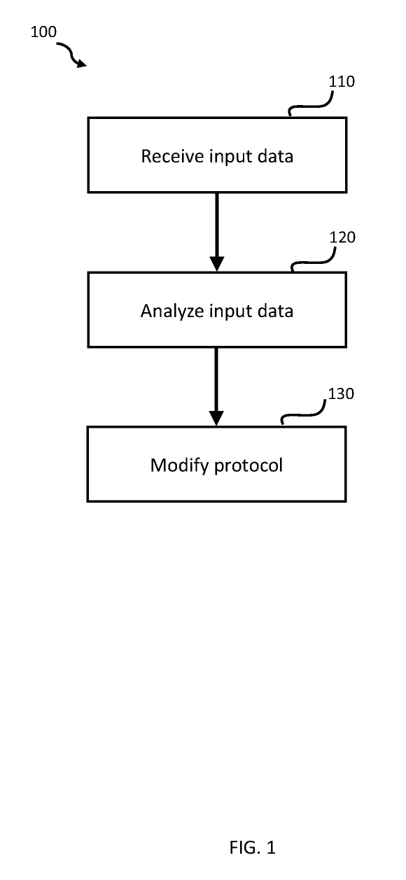

FIG. 1 illustrates a general flow chart of various embodiments of a method 100 for logistical management of a cargo shipment. At step 110, input data related to the cargo shipment are received. In various embodiments, these data may have been collected at any point along a path from producing or growing the items that comprise the cargo up to and including the point of delivery to a recipient. The input data may then be analyzed (step 120), and a logistical or movement protocol associated with the cargo shipment may be modified (step 130).

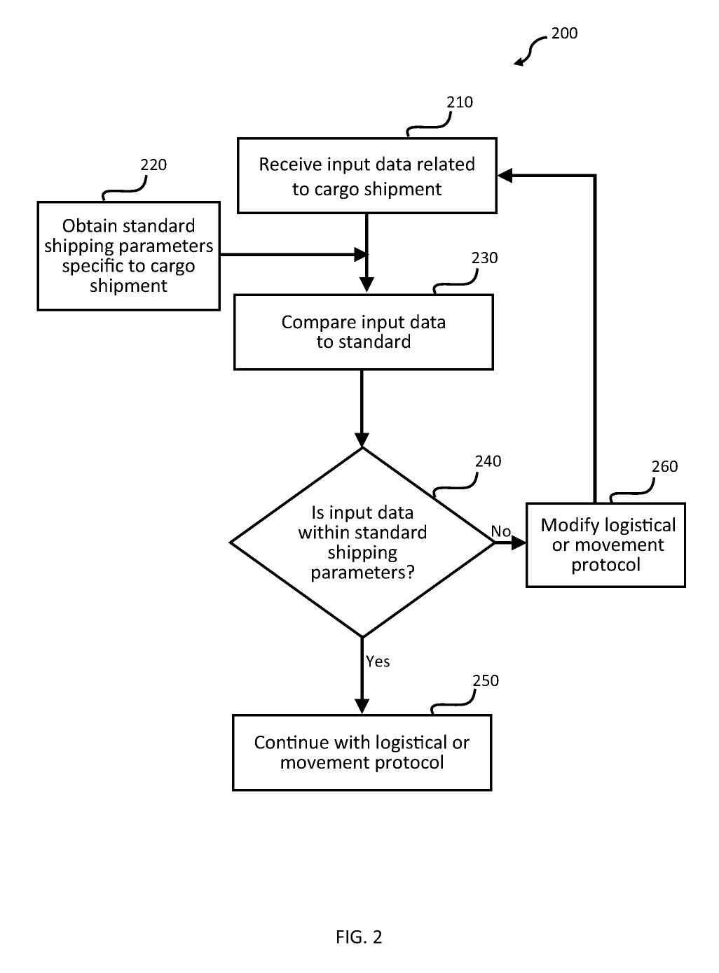

In FIG. 2, various embodiments of the methods of the present invention are exemplified by method 200. A variety of input data may be received that are related to the cargo shipment (step 210), and standard shipping parameters may be obtained specific to the cargo (step 220). Standard shipping parameters may specify a number of conditions that should be maintained during shipment to maintain quality at the highest level possible. These parameters may be specific to particular products (for the most part perishable products). One example of standard shipping parameters is published by the United States Department of Agriculture (USDA), Protecting Perishable Foods During Transport by Truck, Handbook Number 669, September 1995, Reprinted July 2006. The following are excerpts from the document for several perishable foods:

Apples
“Apples ripen steadily at temperatures above 40° F. (4° C.). Therefore, refrigerate them immediately after harvest. Hold and transport most varieties at the 30° to 32° F. (−1° to 0° C.) temperature range. Some varieties, such as McIntosh, are subject to chilling injury at long exposure to temperatures below 38° F. (3° C.)
Recommended transport conditions:
Desired transit temperature:
   Most varieties: 30° to 32° F. (−1° to 0° C.)
   Cortland, McIntosh, and Yellow Newtown: 38° to 40° F. (3° to 4° C.)
Desired relative humidity:
   90 to 95 percent
Highest freezing point:
   30° F. (−1.1° C.)”

Potatoes
“Early crop, or new, potatoes are harvested and shipped from the southern states during the winter, spring, and summer. Because these potatoes are shipped before their skin has had time to set or mature, they are easily skinned and bruised. Broken skins open the way for decay organisms and tissue browning at the surface and lower the market value of the product. Potatoes, fortunately, have the inherent ability to seal skin breaks by producing suberin and wound periderm, which are essentially new skin. This self-healing process proceeds best at a high humidity and temperatures of 60° to 70° F. (16° to 21° C.). If newly harvested potatoes are to be in transit for more than 48 hours, the lower portion of this temperature range is recommended.
Desired transport temperature:
   Early crop—for table, 50° to 60° F. (10° to 16° C.)
      for chipping, 65° to 70° F. (18° to 21° C.)
   Late crop—for table, 40° to 50° F. (4° to 10° C.)
      for chipping, 50° to 60° F. (10° to 16° C.)
Desired relative humidity:
   90 percent
Highest freezing point:
   30.9° F. (−0.6° C.)”

Shell Eggs
“Shell eggs are fragile and highly perishable. Even though it is not outwardly visible, egg quality deteriorates rapidly under poor environmental conditions.
Thoroughly clean and precool the truck or trailer to at least 45° F. (7° C.) before eggs are loaded. Since eggs absorb odors, ensure that the vehicle is free of residual odors. Do not ship eggs in mixed loads, especially not with citrus fruits, onions, or potatoes.
Recommended transport conditions:
Desired transit temperature:
   40° to 45° F. (4° to 7° C.)
Desired relative humidity:
   80 to 85 percent
Average freezing point:
   28.0° F. (−2° C).”

Standard shipping parameters may also be obtained from other sources, such as the University of California. The University of California has published a variety of documents to aid in the shipping of perishable cargo. One such publication is Postharvest Technology of Horticultural Crops, Publication 3311, Third Edition, Adel A. Kader, Technical Editor. An exemplary sample of this document is included as Appendix A. The information in the University of California publication provides more extensive data than the USDA publication discussed above. For example, in addition to storage temperature and humidity, the University of California publication includes ratings on the amount of ethylene production and ethylene sensitivity, storage life, beneficial controlled atmosphere conditions (such as percent oxygen and percent carbon dioxide), and response to controlled atmosphere conditions. A variety of other information relevant to shipping perishable cargo is also presented such as indices of maturity and controlled ripening procedures.

At step 230, a comparison is made between the input data and the standard shipping parameters. In various embodiments, the input data that corresponds to the standard shipping parameters is compared to the acceptable ranges for those parameters (for example, the input data for internal temperature is compared to the standard range for temperature). If the results of the comparison (step 240) indicate that the input data was in range, then the logistical or movement protocol may proceed unchanged (step 250). However, if the input data is not within range, then the logistical or movement protocol may be modified (step 260) and the cycle may repeat at step 210. The logistical or movement protocol may be further modified or modified in a different manner based on the severity of the out of range condition or the duration of the out of range condition.

In certain embodiments, the analysis of the input data is a simple comparison as described above. In various other embodiments, the comparison may involve a more complex algorithm. As may be evident from the excerpt of the USDA document above, a number of the input parameters may not have accepted standardized values or ranges established for them. In such cases, various embodiments may assign a weight to each of the input data parameters. The analysis of the input data may then involve calculating an overall value that takes into account the input data for each parameter, whether the input data is within the standard range when such a range is available, and the weighted value of each additional parameter input data.

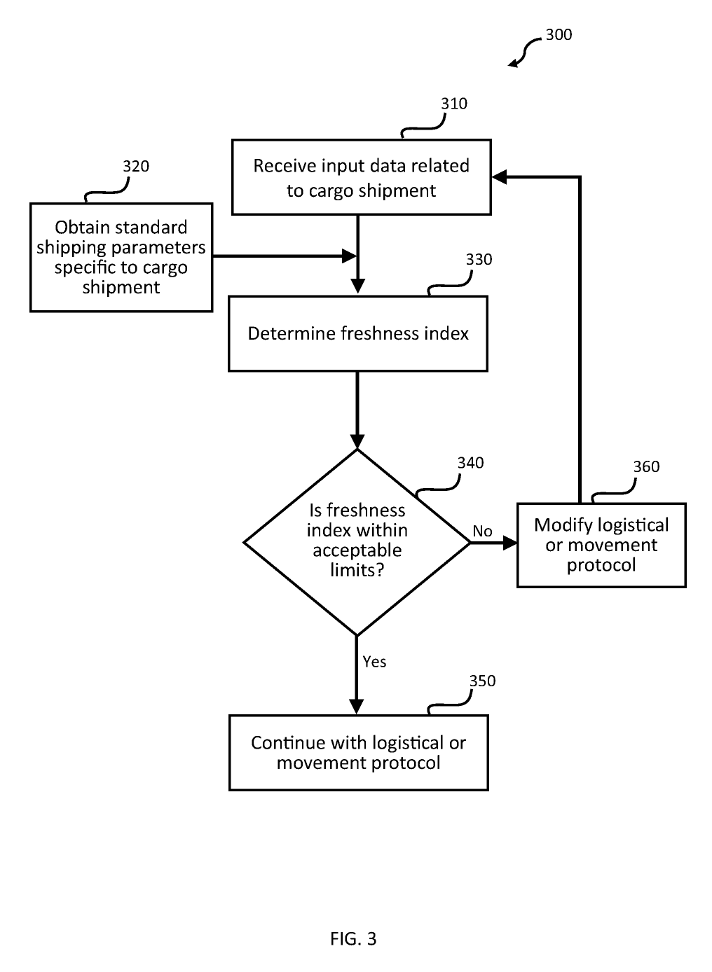

As illustrated in FIG. 3, various embodiments may include a determination of a “freshness index” according to method 300. Data inputs (step 310) and standard shipping parameters (step 320) may be obtained as described above for method 200 of FIG. 2. An algorithm or other analysis may be used to evaluate these data and parameters, with a result being a determination of the freshness index (step 330). The freshness index may provide, for example, a numerical value that can be related to the expected freshness of the cargo considering the conditions the cargo was exposed to during shipping (step 340). For example, the range of the freshness index may be 1 to 10. A value above 7 may indicate that the quality of the shipment may be expected to be close to the quality prior to shipping. In this case, the logistical or movement protocol may proceed unchanged (step 350). Inversely, a value less than 3 may indicate serious quality problems with the shipment, in which case the logistical or movement protocol may be modified (step 360) and the cycle may repeat at step 310. A number of freshness index determinations may be made during the shipment.

In various other embodiments, the result of the input data analysis may be a determination of the remaining useful life of the cargo. For example, the standard shipping parameters may relate how shipping conditions accelerate or retard decay of the cargo. The input data analysis may take into account each relevant parameter and determine the overall effect of the parameters on the remaining useful life of the cargo. Upon receipt of the shipment, various embodiments of the method may provide the recipient with an estimate of the remaining useful life of the cargo. Additionally, the analysis may also take into account the intended use of the cargo. For example, apples being shipped to a processing plant as raw material for the production of apple sauce may have a longer useful life than apples being shipped to a grocery store for consumer purchase.

The modification of the logistical or movement protocol under various embodiments may comprise changing any parameter or group of parameters for which input data are obtained, or triggering an event to occur that is not related to input data. For example, if the results of the input data analysis indicate that the cargo is decaying at a higher rate than expected because ethylene levels have increased in the shipping container, then ozone may be injected into the shipping container to slow the decay. Similarly, adjusting the temperature within the shipping container downward may achieve the same effect, or both ozone injection and a lower temperature may be needed to sufficiently control the rate of decay.

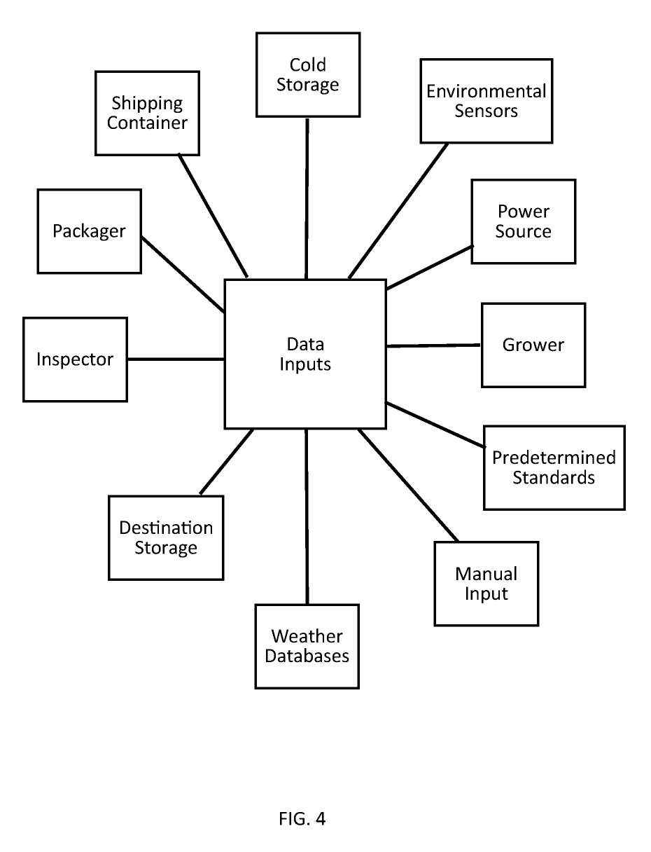

As illustrated in FIG. 4, which is intended to be exemplary and in no way limiting the input data, the input data of FIGS. 2 and 3 may be obtained at any point along the life of the cargo being shipped. In general, the input data may be divided into three primary groups: external data obtained prior to shipment, internal data obtained during shipment, and external data obtained during shipment. Other data may also be obtained after the cargo shipment arrives at its destination. For produce and other crops, external data prior to shipment may include data from the grower pertaining to the cultivation of the product. Examples of such input data may include soil conditions (e.g., pH, phosphate content, moisture content, nutrient content) prior to planting; identification of and amounts of herbicides, fungicides, and fertilizers applied during cultivation; weather conditions during the growing cycle (e.g., rainfall amounts, solar radiation levels, temperature ranges, wind speed); source and type of seed or seedlings; date and time of harvest; and the like. Pre-shipment external data may also include the results of inspection, such as grade or quality, as well as information from the packager. The packager may supply data, for example, on the time at the packaging facility, which processing line at the packaging facility processed the product, equipment problems during packaging, and environmental conditions within the packaging facility.

External data obtained prior to shipment may also include time criticality of the shipment. The spoilage rate of the cargo may be extraordinarily high, requiring that the cargo shipment move without delay to its destination. Other cargo may have a slow spoilage rate, and thus has a lower time criticality. While the embodiments of the present invention are discussed primarily in terms crops and other organic products, inorganic cargo may also have a high time criticality. For example, delicate electronic components and devices may have a low heat tolerance. The recipient may need verification that a temperature threshold was not exceeded during shipment.

In the pharmaceutical realm, temperature extremes during shipment may also be critical to the stability of drugs or raw materials for manufacturing. Insulin is an example of a drug that is susceptible to extremes of both high and low temperatures. Exposure to temperatures outside recommended ranges during shipping may affect the quality of the insulin. Because serious health issues may result from improperly stored insulin, the recipient needs verification that proper storage conditions were maintained during shipment so that the insulin will meet the specifications for insulin in the United States Pharmacopeia upon distribution.

Beyond perishable cargo, other cargo may have requirements unrelated to storage conditions. For example, parts being shipped to an automobile assembly plant may be shipped on a just-in-time (JIT) schedule. The JIT schedule may dictate that the cargo arrive precisely on a certain date, or even at a specified hour on that date.

In various embodiments, internal data obtained during shipment primarily relates to the conditions to which the cargo was directly exposed during shipping. These conditions may be environmental, such as temperature, humidity, pressure, and concentration of chemical species or ionic species in the air surrounding the cargo (e.g., oxygen, nitrogen, ozone, methane, ethylene, carbon monoxide, carbon dioxide, ultraviolet light, and pathogens); or the conditions may be physical, such as vibration, shock, acceleration forces, and lateral movement.

External data obtained during shipment, according to various embodiments of the present invention, are primarily associated with the physical systems related to the shipping container and mode of shipping (e.g., truck, train, container, ship, and airplane). For perishable cargo, the shipping container and/or the mode of shipping may be refrigerated; thus, external data obtained during shipment may relate to the functionality of refrigeration systems. For example, the external data may include monitoring of a power source, power status of the refrigeration unit, voltage fluctuations and amperage load of electrical input to the refrigeration unit, high and low condensing pressure, compressor cycling, refrigerant charge, door status, container integrity, and alarms associated with equipment malfunction. Other external data obtained during shipment may include GPS coordinates, transport time, and maintenance events. Other external data may be obtained from shipping documents that accompany the cargo shipment, such as route, pickup and delivery dates, pickup and delivery locations, booking information, specifications for the type of packaging used, number of individual packages in the shipment, weight of individual packages and the entire shipment, grouping with other cargo containers, and the like.

It will be understood by one skilled in the art that the above discussion of input data is exemplary and is not comprehensive. One skilled in the art will readily recognize that a wide variety of data other than that discussed above may be obtained and may be used as input data for the methods of the present invention.

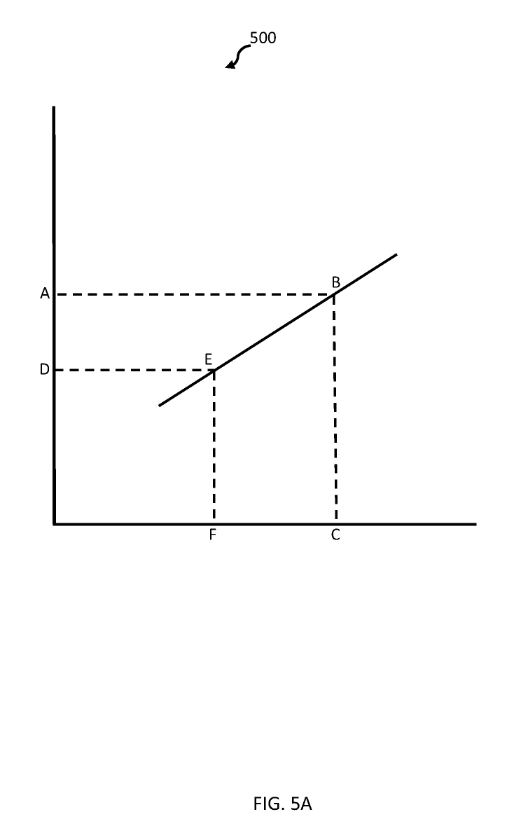

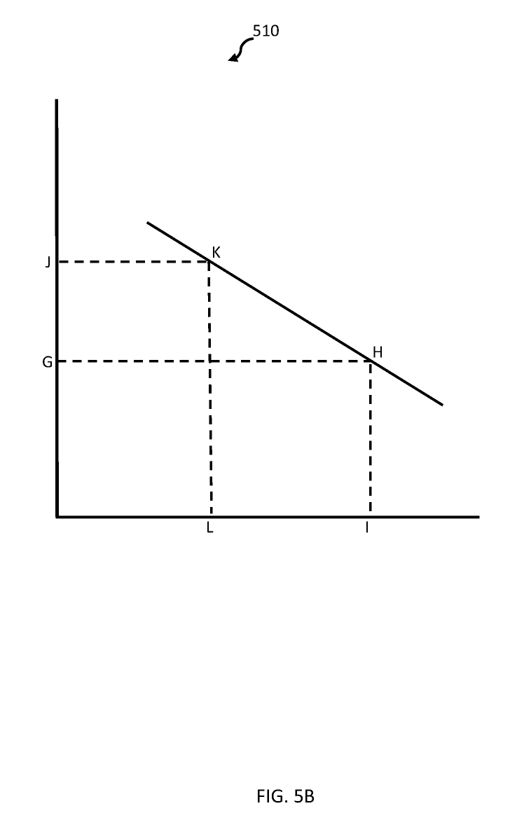

FIG. 5A presents an example of how the results of the input data analysis may be used to modify a logistical or movement protocol for a single standard shipping parameter according to various embodiments. In this example, the x-axis of graph 500 in FIG. 5A may represent a percentage of useful life that has been consumed during storage and the y-axis may represent planned storage time. The current input data may indicate that the storage time is “A” on the y-axis. Analysis of the input data (the analysis is represented by the line E-B of graph 500) estimates that the percentage of useful life of the cargo that will be consumed during storage under current conditions is “C.” However, the recipient desires that only “F” percent of the useful life be consumed during storage. Therefore, further analysis of the input data indicates that the planned storage time should be decreased from “A” to “D” in order to meet the recipient's requirements.

Similarly, graph 510 in FIG. 5B could indicate the value of the cargo in various embodiments. For example, the x-axis could represent the value of the cargo and the y-axis represents the percentage of the cargo that is expected to be spoiled upon arrive at the recipient. A contract between the recipient and the shipper states that the cargo will arrive with “G” percent spoilage and the resulting value of the cargo (i.e., the amount the recipient is willing to pay for the cargo at arrival) is “I.” During shipping, the recipient may receive a variety of input data related to the cargo and the shipping conditions. Analysis of the input data (the analysis is represented by the line K-H of graph 510) may indicate that now the expected percent spoilage has increased to “J” with the resulting value of the cargo dropping to “L.” The recipient may then contact the shipper and renegotiate the price the recipient is willing to pay for the cargo.

The analysis of the data as illustrated in FIGS. 5A and 5B may also be done by the shipper in various embodiments. The input data may be received by the shipper, either directly at the mode of transportation or at a location remote from the cargo. The shipper may track the input data over time and use the methods of the present invention to predict spoilage, value, useful life, freshness, and the like and modify the logistical or movement protocol accordingly. For example, the shipper may have a number of shipping containers in a warehouse ready for shipment but a limited number of trucks available to move the shipping containers. The shipper may use the methods of the present invention to receive input data on each of the cargo containers and estimate the spoilage, value, useful life, etc. for the cargo in each container. Using this information, the shipper may then prioritize the order of shipping the cargo containers to minimize loss in value while still meeting shipping deadlines.

In various embodiments, the input data may be received by a third party (other than the shipper, recipient of the cargo, or original owner of the cargo). The third party may track a number of shipments and receive input data on these shipments. Based on predetermined information such as shipping schedules and expected value (useful life, spoilage, freshness) of the cargo, the third party may generate a report that is sent to any or all of the shipper, recipient, original owner, insurance company, or any other entity that has an interest in the cargo. The report may provide the current status of the shipment and indicate whether there are any negative issues related to the shipment. Similarly, the report could be generated by the shipper, recipient, or original owner of the cargo.

In various embodiments, the methods of the present invention may be used to monitor and reduce energy consumption of the cargo container. Many perishable cargos are shipped in refrigerated containers. As discussed above, there may be a recommended range for the temperature within the cargo container. The shipper may deliberately set the temperature at the low end of the recommended range in an attempt to assure minimum spoilage. While this may have the desired effect on spoilage, keeping the temperature at the low end of the range will also result in maximum energy usage. Instead, the shipper may use the methods of the present invention to determine what temperature is required to meet the desired condition of the shipment at the point of delivery. For example, the recipient may accept as much as 8 percent spoilage while still paying full price for the cargo. Analysis of the input data may indicate that only 3 percent spoilage is expected when the temperature is maintained at the low end of the range, while 7 percent spoilage is expected when the temperature is maintained at the high end of the range. Based on this information, the shipper may make the decision to increase the temperature of the shipping container, thereby reducing energy consumption.

The methods of various embodiments of the present disclosure may also be used when there is a dispute over the condition of a shipment upon arrival at the recipient. In the above example, suppose that the cargo arrives with 10 percent spoilage rather than the expected 7 percent spoilage. The recipient may place the blame for the excess spoilage on the shipper and refuse to pay full price. The shipper may use the methods of the present invention to generate a report base on the input data and analysis of the input data indicating that the spoilage should have been within acceptable levels based on the actions taken by the shipper. This may indicate that the shipper is not at fault and perhaps the original quality of the cargo as received by the shipper was not at the level claimed by the original owner of the cargo.

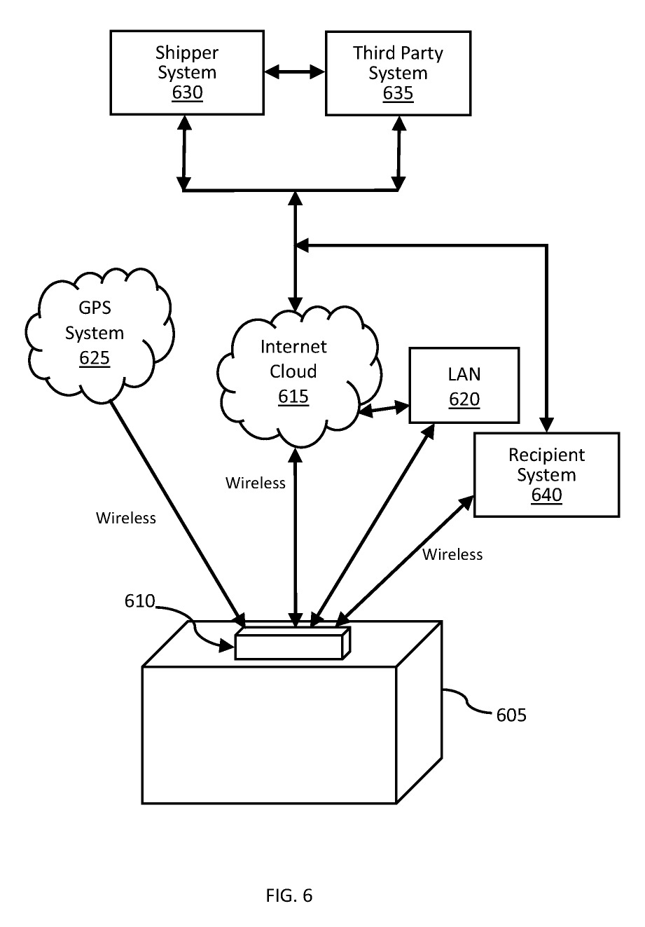

The input data may come from a number of sources as indicted previously in FIG. 4. The data may be input over a relatively long period of time, such as when data are obtained prior to a crop being planted. Such data may be stored within a database maintained by the third party (or any other entity involved in production, packaging, shipping, receiving, or insuring of the cargo). At some point, the cargo may be placed in a cargo container. As illustrated in FIG. 6, the cargo container 605 may be equipped with a data logging and communications system 610. Data logging and communications system 610 may be a computer system or other electronic system capable of interfacing with a variety of sensor located within the shipping container 605, such as a relative humidity sensor proximate to the cargo. Data logging and communications system 610 may also be capable of interfacing with systems attached to or integrated with the cargo container 605 such as power supplies, controllers, and refrigeration units. Data logging and communications system 610 may store data and may communicate the data continuously or periodically, either wirelessly or through a hard wired connection.

Data logging and communications system 610 may communicate with GPS system 625 to ascertain position and movement of the cargo container 605. In order to enable communication with systems outside the shipping container, data logging and communication system 610 may communicate through a hard-wired connection with a local area network (LAN) 620 or wirelessly through an Internet or cloud computing system 615. Communication links may then be established with a shipper computer or communications system 630, a recipient system 640, or third party system 635. These communication links may be two-way links such that the shipper, recipient, or third party may send information back to the data logging and communications system 610. However, the two-way communication may be limited depending on the entity sending the information. For example, only the shipper may be able to change environmental conditions within the shipping container 605, while the other entities may only have the ability to monitor the conditions.

The data logging and communications system 610 in various embodiments may be equipped to allow manual entry of data. An operator may scan a barcode or other identification symbols on the cargo as the cargo is placed in the shipping container 605. The operator may also manually enter an identification number into the data logging and communications system 610. In various other embodiments, the data logging and communications system 610 may be equipped to automatically read identification information for the cargo, for example by automatically reading an RF identification device attached to the cargo. In either case, once the cargo is associated with a cargo container 605, all previously acquired data for that cargo (such as crop data, processing and packaging data, prior shipping data, and other data as previously described) may then be associated with that cargo container 605. All of the available data may then be used as input data.

According to various embodiments, the input data distributed by the data logging and communications system 610 may be received and analyzed utilizing servers at a fixed location such as the recipient system 640, or the cloud-based computing environment 615 that collects, processes, analyzes, and publishes datasets. In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, such as Google™ or Yahoo!™, or such systems may be accessible to outside users who deploy applications within the computing infrastructure to obtain the benefit of large computational or storage resources.

The cloud 615 may be formed, for example, by a network of web servers with each server (or at least a plurality thereof) providing processor and/or storage resources. These servers may manage workloads provided by multiple users (e.g., cloud resource customers or other users). Typically, each user places workload demands upon the cloud 615 that vary in real-time, sometimes dramatically. The nature and extent of these variations typically depend upon the type of business associated with the user.

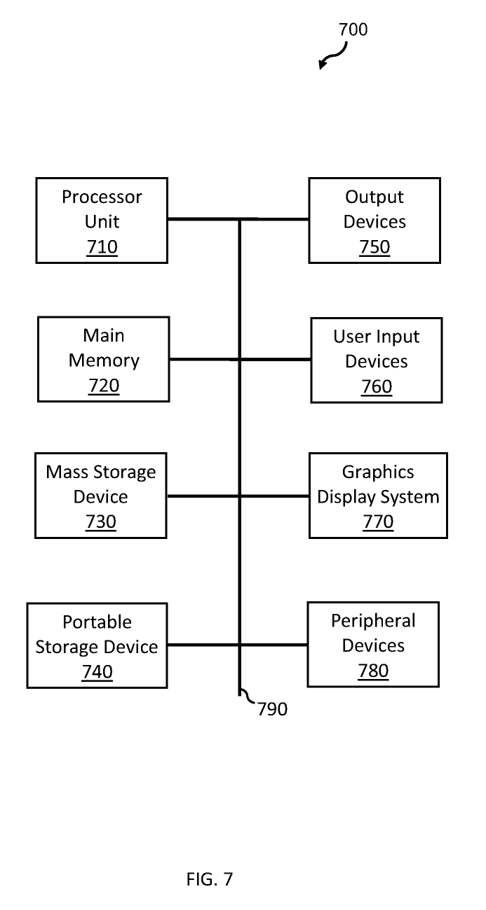

FIG. 7 illustrates an exemplary computing system 700 that may be used to implement, for example, the shipper system 630, third party system 635, or recipient system 640. The computing system 700 of FIG. 7 includes one or more processor units 710 and main memory 720. Main memory 720 stores, in part, instructions and data for execution by processor 710. Main memory 720 can store the executable code when the system 700 is in operation. The system 700 of FIG. 7 may further include a mass storage device 730, portable storage device(s) 740, output devices 750, user input devices 760, a graphics display system 770, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device(s) 740, and graphics display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present technology for purposes of loading that software into main memory 720.

Portable storage device 740 operates in conjunction with a portable non-volatile storage media, such as a floppy disk, compact disk or digital video disc, to input and output data and code to and from the computer system 700 of FIG. 7. The system software for implementing embodiments of the present technology may be stored on such a portable media and input to the computer system 700 via the portable storage device 740.

User input devices 760 provide a portion of a user interface. User input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Graphics display system 770 may include a liquid crystal display (LCD) or other suitable display device. Graphics display system 770 receives textual and graphical information, and processes the information for output to the display device.

Peripheral devices 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present technology and are intended to represent a broad category of such computer components that are well known in the art. Thus, the computer system 700 of FIG. 7 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, iOS, Android, and other suitable operating systems.

Some of the above-described functions may be composed of instructions that are stored on storage media (e.g., computer-readable media). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The term “computer-readable storage media” as used herein refer to any media or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The above description is illustrative and not restrictive. Many variations of the technology will become apparent to those of skill in the art upon review of this disclosure. The scope of the technology should, therefore, be determined not with reference to the above description, but instead should be determined with reference to the appended claims along with their full scope of equivalents.

What is claimed is:

1. A method for logistical management of a cargo shipment, comprising:
receiving input data related to perishability of the cargo;
analyzing the input data; and
modifying a logistical or movement protocol for the cargo based on the results of the input data analysis.

2. The method of claim 1, wherein receiving input data comprises receiving data from one or more sensors located proximate to the cargo.

3. The method of claim 2, wherein the one or more sensors detect one or more environmental conditions to which the cargo is exposed.

4. The method of claim 3, wherein the one or more environmental conditions is selected from the group consisting of relative humidity, temperature, carbon dioxide concentration, ozone concentration, and combinations thereof.

5. The method of claim 2, wherein the one or more sensors detect one or more chemical species.

6. The method of claim 2, wherein the one or more sensors detect one or more ionic species.

7. The method of claim 1, wherein analyzing the input data comprises comparing the input data to at least one predetermined standard.

8. The method of claim 7, wherein the logistical or movement protocol is modified when the input data deviates from the at least one predetermined standard by at least a predetermined amount.

9. The method of claim 8, wherein the predetermined amount varies according to contents of the cargo.

10. The method of claim 1, wherein modifying the logistical or movement protocol comprises lengthening or shortening a storage duration or changing an environmental storage parameter.

11. The method of claim 1 further comprising determining an expected useful life of the cargo and modifying a storage duration based on the expected useful life of the cargo.

12. The method of claim 1, wherein the cargo is an agricultural product, and receiving input data comprises receiving data related to process, inspection, or environmental conditions prior to storage.

13. The method of claim 1, further comprising receiving input data related to a specific cargo container.

14. The method of claim 13, further comprising applying a first modified logistical or movement protocol to the specific cargo container and applying a second modified logistical or movement protocol to another cargo container.

15. A method for logistical management of cargo shipments, comprising:
receiving input data related to time criticality of the cargo;
comparing the input data to at least one predetermined standard; and
modifying a logistical or movement protocol for the cargo when the input data deviates from the at least one predetermined standard by at least a predetermined amount.

16. A method for manipulating a logistical or movement protocol for a cargo container, comprising:
receiving input data related to a time criticality of cargo in the cargo container;
comparing the input data to at least one predetermined standard;
determining a remaining useful life of the cargo based on the input data comparison; and
determining a movement priority for the cargo based on the remaining useful life of the cargo.

17. The method of claim 16, further comprising adjusting storage conditions for the cargo based on the movement priority of the cargo.

18. The method of claim 17, wherein adjusting the storage conditions comprises adjusting the temperature of the cargo container.

19. The method of claim 17, wherein adjusting the storage conditions comprises adjusting the humidity of the air or concentration of other gases in proximity to the cargo.

20. A method for determining a logistical or movement protocol for a cargo shipment, comprising:
determining a desired delivery time for the cargo;
receiving input data related to time criticality of the cargo;
comparing the input data to one or more predetermined standards; and
modifying a logistical or movement protocol for the cargo based on the results of the input data analysis.

21. A method for determining a logistical or movement protocol for a cargo shipment, comprising:
receiving or determining input data comprising:
a standard storage time for the cargo;
standard storage conditions for the cargo; and
time criticality of the cargo;
comparing at least a portion of the input data to one or more predetermined standards;
determining a remaining useful life of the cargo based on the input data comparison; and
adjusting one or both of a storage time or storage conditions of the cargo.

22. A method for determining a freshness index for a perishable cargo, comprising:
obtaining data relating how variability in one or more measurable parameters affects the perishable cargo;
creating an algorithm that assigns relative weights to each of the one or more measurable parameters and combines the effects on the perishable cargo of the variability of the one or more measurable parameters; and
calculating the freshness index for the perishable cargo using the algorithm, wherein the freshness index predicts a useful life of the perishable cargo.

23. The method of claim 22, further comprising adjusting a logistical or movement protocol for the perishable cargo based on the freshness index.

24. The method of claim 22, wherein the data comprises at least one predetermined standard.

25. A method for determining a freshness index for a perishable cargo, comprising:
obtaining one or more reference standards relating how variability in one or more measurable parameters affects the perishable cargo;
creating an algorithm that assigns relative weights to each of the one or more measurable parameters and combines the effects on the perishable cargo of the variability of the one or more measurable parameters;
receiving data related to measurement of the one or more measurable parameters and inputting the data into the algorithm; and
calculating the freshness index for the perishable cargo using the algorithm.

26. The method of claim 25, wherein the freshness index predicts a useful life of the perishable cargo.

27. The method of claim 25, further comprising adjusting a logistical or movement protocol for the perishable cargo based on the freshness index.

28. The method of claim 25, further comprising adjusting storage conditions for the cargo based on the freshness index.
